(19) United States
(12) Patent Application Publication
(10) Pub. No.: US 2025/0147668 A1
(43) Pub. Date: May 8, 2025

(54) Self-Learning Data Linearizer

(71) Applicant: Microsemi SoC Corp., Chandler, AZ (US)

(72) Inventors: Balaji Chegu, Bangalore (IN); Sateesh Kumar Gadamsetty, Bangalore (IN); Arunkumar Devidas Naik, Bangalore (IN); Kavita Aluri, Hyderabad (IN)

(73) Assignee: Microsemi SoC Corp., Chandler, AZ (US)

(21) Appl. No.: 18/931,180

(22) Filed: Oct. 30, 2024

(30) Foreign Application Priority Data
Nov. 3, 2023 (IN) 202311075231

(51) Int. Cl. G06F 3/06

(52) U.S. Cl. CPC G06F 3/0613; G06F 3/0659; G06F 3/0673

(57) ABSTRACT

A circuit, and method for using same comprising, a first intermediate memory communicatively coupled with a vector processor and a RAM, wherein the vector processor is communicatively coupled with the RAM, an address sequence memory to store non-linear RAM addresses corresponding to linear locations in the first intermediate memory, a data sequencer to read a first frame of data from the RAM to the first intermediate memory based on addresses stored in the address sequence memory, and the first intermediate memory to provide a linearized frame of data to the vector processor to execute a vector instruction

### RELATED APPLICATIONS

This application claims priority to Indian Patent provisional application No. 202311075231, filed on Nov. 3, 2023, the disclosure of which is incorporated by reference in its entirety for all purposes.

### FIELD OF THE INVENTION

The present application relates to systems and methods for improving memory and processing performance, and more particularly, to a self-learning data linearizer for vector processor performance augmentation.

### BACKGROUND

Vector processors can calculate results faster than scalar processors but have limited applicability or require specialized programming. A scalar processor loads one or two scalar values and stores zero or one scalar results. A scalar value (or result) is a single value represented by one standard data unit of the processor. A 32-bit scalar processor operates on one or two 32-bit values. For example, a branch if zero operation would load a single 32-bit value, compare that value to zero and branch to a new instruction sequence if true. In some instruction sets, a first instruction would load the 32-bit value into a register, and a second instruction would compare the register value to zero. In another example, an add instruction mathematically adds two 32-bit numbers to generate a 32-bit result.

A vector processor performs operation on vectors (or arrays) of data. For example, a vector add instruction may simultaneously add eight 32-bit values to eight other 32-bit values to generate eight 32-bit results. In some examples, a vector processor may operate on sixteen 16-bit values to generate sixteen 16-bit results. In some examples a vector processor may operate on thirty two 8-bit values to generate thirty two 8-bit results.

### SUMMARY

In some examples, a circuit is provided comprising a first intermediate memory communicatively coupled with a vector processor and a RAM, wherein the vector processor is communicatively coupled with the RAM; an address sequence memory to store non-linear RAM addresses corresponding to linear locations in the first intermediate memory; a data sequencer to read a first frame of data from the RAM to the first intermediate memory based on addresses stored in the address sequence memory; and the first intermediate memory to provide a linearized frame of data to the vector processor to execute a vector instruction. In certain examples, the circuit comprises a second intermediate memory communicatively coupled to the vector processor and the RAM, wherein the data sequencer is to read a second frame of data from the RAM to the second intermediate memory based on addresses stored in the address sequence memory. In certain examples, the circuit comprises a scalar processor communicatively coupled to the RAM, and an address learning agent to record a first set of memory access addresses by the scalar processor for the first frame of data; and store the first set of memory access addresses in the address sequence memory. In certain examples, the address learning agent is to record a second set of memory access addresses by the scalar processor for a second frame of data; determine the first set of memory access addresses matches the second set of memory access addresses; and indicate the match to the scalar processor. In certain examples, the circuit comprises the data sequencer to write data from the first intermediate memory to the RAM based on addresses stored in the address sequence memory. In certain examples, the address sequence memory and the first intermediate memory are external to the RAM. In certain examples, the vector processor instruction set includes an indicator to fetch data from the first intermediate memory instead of the RAM.

In some examples, a circuit is provided comprising a first intermediate memory communicatively coupled to a vector processor, a scalar processor, and a RAM, the RAM to store a vector program for performing calculations, an address sequence memory to store non-linear RAM addresses corresponding to linear locations in the first intermediate memory, an address learning agent to, while the scalar processor performs the calculations of the program: capture a first set of memory access addresses issued by the scalar processor to the RAM during processing of a first frame of data; map the set of memory access addresses to linear locations in the first intermediate memory; and store in the address sequence memory the mapping of the set of memory access addresses to the linear locations in the first intermediate memory; and a data sequencer to read a first frame of data from the RAM and store the first frame of data to the first intermediate memory based on addresses stored in the prefetch address lookup table, the first intermediate memory to thereby provide linearized data to the vector processor to execute a vector instruction. In certain examples, the circuit comprises a selector to select one of the first intermediate memory and a second intermediate memory from which to fetch linearized data. In certain examples, the address learning agent to: record a second set of memory access addresses by the scalar processor for the second frame of data; and determine the first set of memory access addresses matches the second set of memory access addresses. In some examples, the scalar processor to, based on the match determination, modify the program to access the first intermediate memory. In certain examples, the circuit comprises a second intermediate memory to store results generated by the vector processor; and the data sequencer to write the results of the vector processor from the second intermediate memory to the RAM based on RAM addresses stored in the address sequence memory. In certain examples, the address sequence memory and the first intermediate memory are external to the RAM. In certain examples, the vector processor supports an instruction to access data from the first intermediate memory.

In some examples, a method is provided comprising reading a sequence of non-contiguous addresses from an address sequence memory, prefetching a first frame of data from a RAM using the sequence of non-contiguous addresses, storing that first frame of data in a first intermediate memory as a first linearized frame of data, receiving a vector load instruction to load a portion of the first frame of data, loading the portion of the first frame of data into the vector processor from the first intermediate memory, and executing the vector instruction with the received portion of the first frame of data as an operand. In certain examples, the method comprises selecting a second intermediate memory from which to load linearized data into the vector processor. In certain examples, the method comprises receiving scalar instructions equivalent in result to the vector instruction at a scalar processor; recording a first set of memory access addresses consisting of each memory access address loaded from RAM while executing the scalar instructions to process the first frame of data; linearizing the first set of memory access addresses; and storing the linearized memory access addresses in the address sequence memory. In certain examples, the method comprises recording a second set of memory access addresses in executing the scalar instructions to process a second frame of data; and comparing the first set of memory access addresses and second set of memory access addresses to determine a match. In certain examples, the method comprises storing in the address sequence memory RAM addresses corresponding to locations in a second intermediate memory; during execution of the vector instruction, storing a result in the second intermediate memory; and writing the result from the second intermediate memory to the RAM based on one of the addresses corresponding to locations in the second intermediate memory. In certain examples, the method comprises determining from the vector instruction that execution results will be stored in the second intermediate memory.

### BRIEF DESCRIPTION OF THE DRAWINGS

FIG. 1 is an illustration of an example system for improving performance of a computer with a vector processor, according to examples of the present disclosure.

FIG. 2 is an illustration of memory access patterns in a vector processing system, according to examples of the present disclosure.

FIG. 3 is an illustration of a vector processing system for learning memory access patterns, according to examples of the present disclosure.

FIGS. 4A and 4B illustrate a vector processing circuit including a self-learning linearizer, according to examples of the present disclosure.

FIG. 5 is an illustration of memory accesses in a multi-state calculation, according to examples of the present disclosure.

FIG. 6 is an illustration of learned addresses, according to examples of the present disclosure.

FIGS. 7A and 7B illustrate data addressing, according to examples of the present disclosure.

FIG. 8 is an illustration of data access timing, according to examples of the present disclosure.

FIG. 9 is an illustration of a method for performing a self-learning data linearization process, according to examples of the present disclosure.

FIG. 10 is an illustration of data access timing, according to examples of the present disclosure.

FIG. 11 is an illustration of data access timing, according to examples of the present disclosure.

FIG. 12 is an illustration of an example system for improving performance of a computer with a vector processor, according to examples of the present disclosure.

FIG. 13 is an illustration of an example system for improving performance of a computer with a vector processor, according to examples of the present disclosure.

FIG. 14 is an illustration of an example method for improving performance of a computer with a vector processor, according to examples of the present disclosure.

### DETAILED DESCRIPTION

Applications executing on a vector processor may face performance slowdowns when memory accesses are nonlinear. A vector processor may have a wide data path to memory and may be optimized for loading linearly arranged, contiguous data sets. Vector processors may slow down in situations where data is not arranged in unit strides in memory. In some examples, applications performing a fast Fourier transform (FFT), image/video processing, artificial intelligence, and machine learning algorithms may require processing of data that is not well suited for standard loads and stores by a vector processor. A self-learning linearizer may be coupled to the memory and CPU to enhance the data flow and improve performance of the vector processor. An application may be executed in a learning mode to allow an observation circuit to capture and/or analyze the memory access patterns. The application may be modified with an addressing mode change to take advantage of a prefetch/postprocessing memory system. In some examples, an operation may be modified to access linearly arranged data in a ping memory along with a signal to the data prefetch unit to prefetch data into the ping memory based on a predetermined address sequence. In some examples, the predetermined address sequence is determined using the address learning hardware described below. In some examples, the predetermined address sequence may be determined using an emulator or software instrumentation system. The self-learning linearizer augmented application may perform more efficiently with the self-learning linearizer prefetching a frame of data to store in linear fashion in an intermediate memory of the present disclosure. In some examples, a vector processor instruction may include an indicator to fetch data from a first intermediate memory (e.g., a ping memory) instead of RAM.

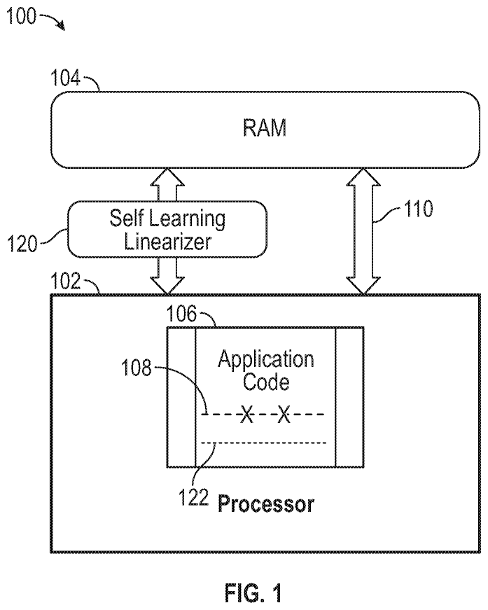

FIG. 1 is an illustration of an example system for improving performance of a computer with a vector processor, according to examples of the present disclosure. FIG. 1 illustrates circuit 100, which includes memory 104 and central processing unit (CPU) 102. Memory 104 may be dynamic random-access memory (DRAM) and circuit 100 may include a memory controller to refresh the values in memory 104 at a regular interval. CPU 102 may load data from, or store data to, memory 104 via memory bus 110 or via self-learning linearizer 120. CPU 102 may execute application code 106, which includes non-linear memory access addresses in line 108. In some examples, the code in line 108 may be replaced with line 122 to explicitly access data via self-learning linearizer 120. In some examples, non-linear addresses accessed by line 108 may be translated at runtime by self-learning linearizer 120 to access linearized data.

In some examples, CPU 102 may include a scalar processor and a vector processor. Each type of processor may execute an instruction that operates on one or two operands and generates a result or indicates a change in program flow. A result may be logical or numeric. Numeric results may be represented as integers or as real values. The scalar processor may be a reduced instruction set computer (RISC) processing core. In some examples, the scalar processor may operate on two doubleword operands to provide a single doubleword result. In some examples, the vector processor may operate on two operand arrays of doubleword values and provide a result in the form of an array of doubleword values. The vector processor may operate most efficiently when the operand and result arrays are stored linearly in memory 104. For example, an operand array may include four doubleword values. If linearly arranged, each doubleword value may be stored in array order and in consecutive memory locations. For example, the first operand value may have a memory address of 0x00011004 and the second operand value may have a memory address of 0x00011008. The third operand value may have a memory address of 0x0001100C and the fourth operand value may have a memory address of 0x00011010. In another example, an operand value may be an array of byte values with a first value at 0x00011004, a second value at 0x00011009, and so on. In yet another example, the first operand value may be an array of nibble values with the first and second operand values stored at 0x00011004, the second operand value may be an array of nibble values with the third and fourth operand values stored at 0x00011005.

Memory 104 may store data and instructions for operating on that data. An example of instructions stored in memory 104 are illustrated in application code 106. Memory bus 110 may include an address portion and a data portion. A memory bus transaction may signal a read of a memory location, e.g., read four doublewords starting at memory address 0x00110004. In some examples, self-learning linearizer 120 may provide an alternate address and/or data path between CPU 102 and memory 104. Examples of self-learning linearizer 120 are described throughout this disclosure.

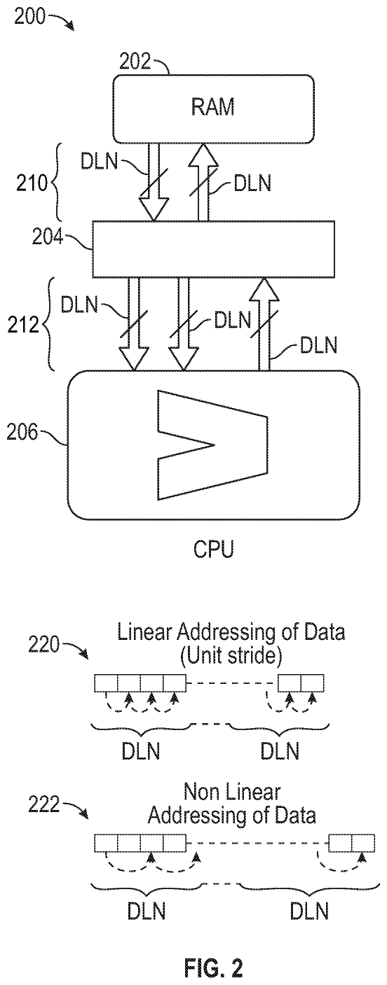

FIG. 2 is an illustration of memory access patterns in a vector processing system, according to examples of the present disclosure. Circuit 200 may represent a vector processing system including RAM 202, register file 204, CPU 206, datapath 210 and datapath 212. In some examples, RAM 202 may be a very large static RAM (VSRAM). Datapath 210 between register file 204 and RAM 202 may include data length (DLN) size bus width in each direction. In one example, DLN may be 256 bits. Datapath 212 may include 2 DLN size buses from register file 204 to CPU 206 and DLN size bus from CPU 206 to register file 204. Datapath 212 may provide 2× read lanes from register file 204 to CPU 206 to allow a vector processor instruction to operate on two input vectors while generating a single output vector.

A vector processor (one of CPU 206) performs most efficiently when input data may be addressed in a linear manner with a unit stride as illustrated in memory representation 220. In this scenario and in some examples, each memory read operation may load two contiguous blocks of DLN bits, process that data in one computational cycle, and output DLN bits of data to be stored in a contiguous portion of RAM. In some examples, each memory operation may operate on two vectors of DLN bits each. Circuit 200 may operate at high clock rates with high bandwidths to memories. In some examples, data access rates (i.e., rates at which data may be read from or written to memory) match data processing rates with high clock frequencies and wide data paths. However, if the data is irregular or includes nonlinear data addressing (i.e., is not unit strided), the processor may be starved and may be forced to spend multiple cycles loading data into its registers before performing an arithmetic or logical operation on that data. For example, if one operand includes data from two non-contiguous memory locations, the circuit 200 would need to read two blocks of memory (each DLN size) to assemble the DLN-size operand before then executing the instruction. An example of non-unit strided data is illustrated in memory representation 222, which illustrates data interleaved in every other memory location. This starvation may render the vector processor incapable of (or inefficient at) solving certain sub-classes of applications. The present disclosure provides a solution to allow efficient use of vector processing for a broader class of applications like image/video processing, artificial intelligence, machine learning, signal processing, and other high performance computing applications.

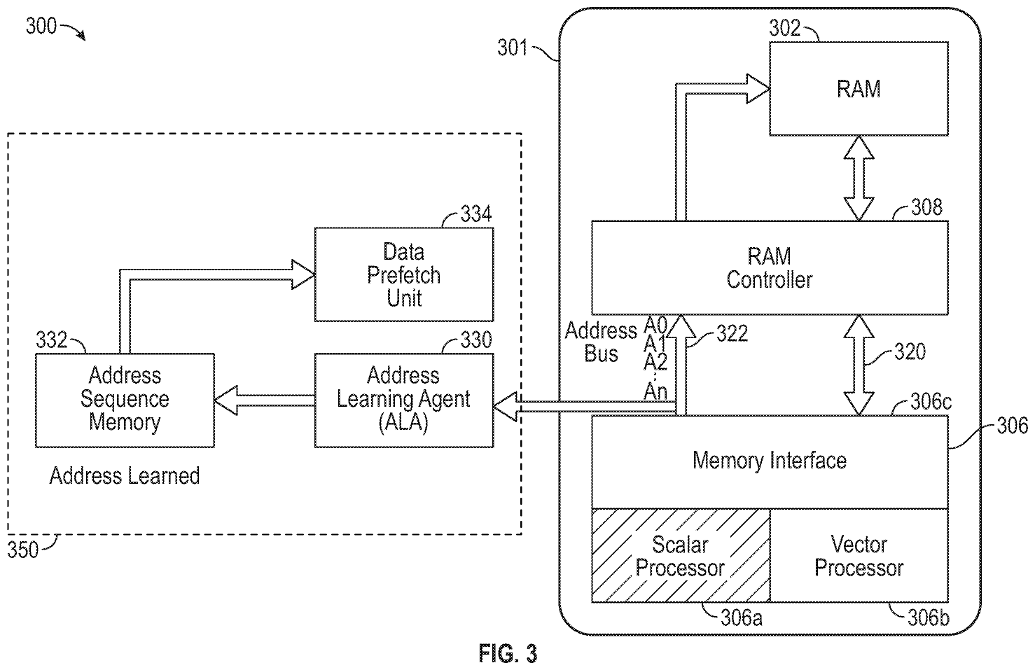

FIG. 3 is an illustration of a vector processing system for learning memory access patterns, according to examples of the present disclosure. Circuit 300 includes data processing system 301, which includes RAM 302, RAM controller 308, memory address bus 322, memory data bus 320, and CPU 306 (which includes scalar processor 306a, vector processor 306b and memory interface 306c). Circuit 300 also includes components of self-learning linearizer 350 that includes address learning agent (ALA) 330, address sequence memory 332, and data sequencer 334. RAM 302 may be a random access memory and may be commonly referred to as a main memory. Memory interface 306c is a circuit that interfaces with one or more memories via an address and data bus to load data from or store data to a memory.

Operating in a learning phase, scalar processor 306a may execute instructions of a program. Scalar ALU loads one or more scalar operands for each scalar instruction and stores up to one scalar result. A scalar value is a single value, e.g., a 32-bit value. Scalar processor 306a accesses data by issuing an address on address bus 332 along with a load or store command. RAM controller 308 executes the memory load/store command using the address to read or write data to or from RAM 302.

As data is accessed by scalar processor 306a address learning agent (ALA) 330 may observe memory access addresses A₀, A₁, A₂, through Aₙ on memory address bus 322. Address learning agent may store memory access addresses A₀, A₁, A₂, through Aₙ in address sequence memory 332 as part of the learning process. At the end of the learning phase of operation, memory access addresses A₀, A₁, A₂, through Aₙ may be loaded into address generation circuit 334 for use during an execution phase. Address sequence memory 332 may store addresses in a prefetch address lookup table for use by address generation circuit 334 to prefetch data before vector processing of that data. Address sequence memory 332 may store addresses in a postprocessing address lookup table for use by address generation circuit 334 to store results generated by vector processing of the prefetched data. In some examples, the prefetch address lookup table may be implemented as a separate data structure from postprocessing address lookup table. In certain examples, a single data structure may store prefetch and postprocessing addresses along with an indication of whether the address was used to load data or store results, wherein the prefetch address lookup table is obtained by filtering the addresses by the load indicator and the postprocessing address lookup table is obtained by filtering the addresses by the store indicator.

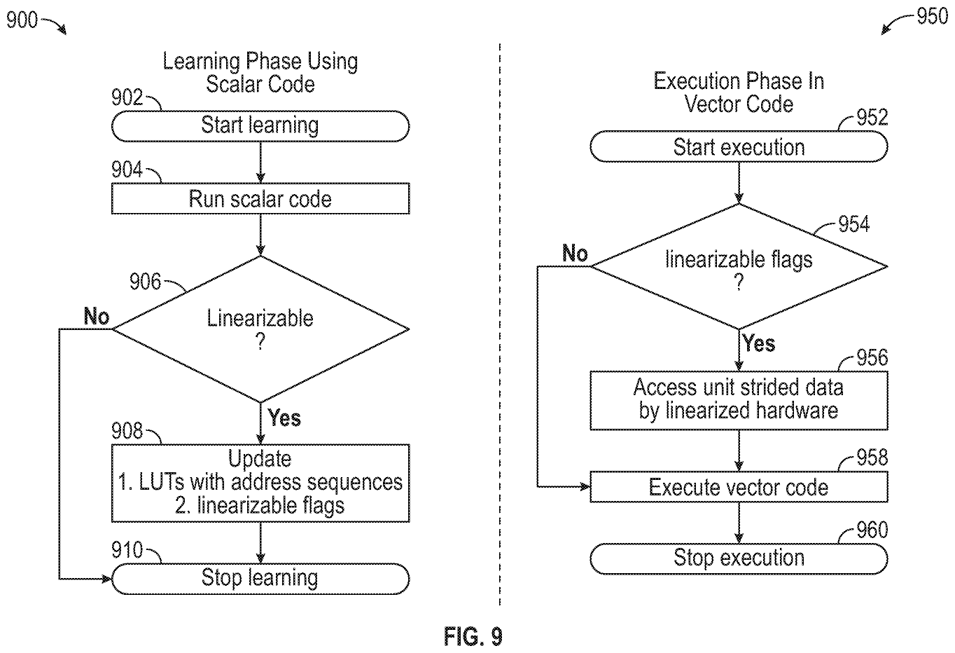

In some examples, processor 306 may be initially executed in scalar mode (illustrated with hashing) to iterate over a few frames of data to learn the memory access pattern. Processor 306 may signal the address learning agent 330 to indicate the start of processing of a frame of data. A frame of data may be a fixed sized unit of data processed on a repeating basis. For example, a stream of video data may be arranged in frames where each frame represents information corresponding to the pixels on a display. In another example, a stream of audio data may be arranged in frames where each frame represents an audio level value for each channel of sound. In some examples, a frame may comprise a set of values captured by a set of sensors at a given point in time, the output of a light show. In other examples, a frame may represent control values in an industrial setting. Address learning agent 330 records a series memory addresses in sequence as the scalar processor 306a accesses RAM 302. The series of addresses is stored in an address sequence memory 332. In some examples, a second or third frame is processed in the same manner and, if the address sequence matches across the frames, the address learning agent 330 records that a pattern exists. As part of this, it updates the algorithm's information by updating address lookup table and also setting the “Linearizable flag” as in 908 (see description of FIG. 9). In some examples, address sequence memory 332 may be a nonvolatile memory for later retrieval. In some examples, the learning phase may compare the address sequence of the first frame to subsequent frames in search of a larger pattern that repeats on some interval greater than a single frame. In one example, if the address sequence for frame 0 matches frame 8, the learning process may compare frame 1 with frame 9 and so forth to determine repetition every eight frames. In some examples, the learning algorithm may capture write address sequences and look for repeating write patterns. An address sequence may be a match if the addresses represent identical offsets of a base address. The address sequence may be used by a data sequencer, as explained below.

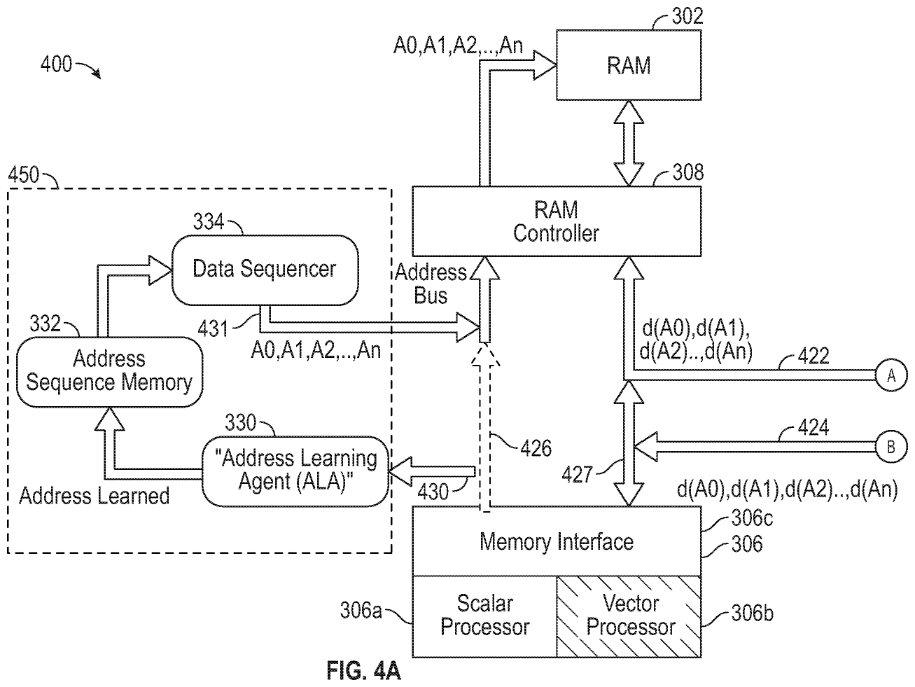

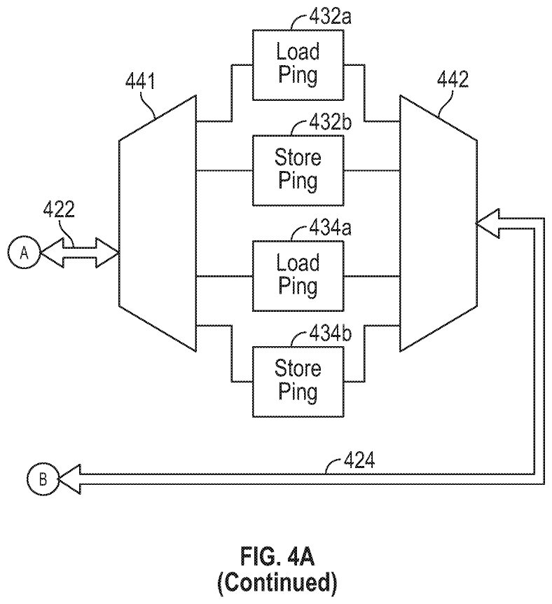

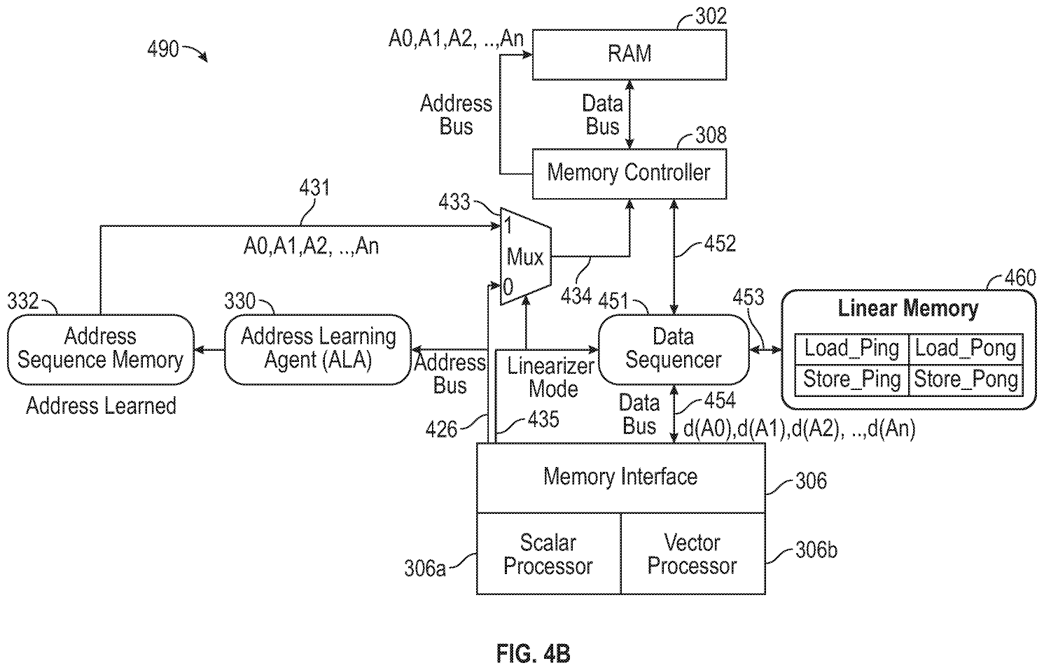

FIG. 4A is an illustration of vector processing circuit including a self-learning linearizer, according to examples of the present disclosure. Circuit 400 includes RAM 302, RAM controller 308, and processor 306. Circuit 400 also includes components of self-learning linearizer 450 that includes address learning agent (ALA) 330, address sequence memory 332, and data sequencer 334. Address learning agent 330 reads memory access addresses via memory address bus interface 430. Data sequencer 334, during an execution phase, may output memory addresses to RAM controller 308 via memory address bus interface 431. In some examples, memory address bus 426 may be controllably segmented to allow direct interface between scalar processor 306a and vector processor 306b and RAM controller 308 at some times and to allow memory addressing by data sequencer 334 at other times. Circuit 400 also includes linear addressed memories 432 and 434. Memories 432 and 434 may be called ping memories as the accesses may alternate between them (ping and pong). Ping memory 432 includes load ping memory 432a and store ping memory 432b. Ping memory 434 includes load ping memory 434a and store ping memory 434b. In some examples, memory data bus 427 may be controllably segmented to allow direct interface between processor 306 (including vector ALU 306b) and RAM controller 308 at some times and to route data reads and writes through ping memories 432 and 434 at other times. Ping memory selector 441 may select which of ping memories 432a, 432b, 434a, and 434b is connected to RAM 302 via memory data bus segment 422. Ping memory selector 442 may select which of ping memories 432a, 432b, 434a, and 434b is connected to processor 306 via memory data bus segment 424. Ping memory selectors 441 and 442 may be implemented as a decoder, multiplexor, with bus enable signals, or other selector circuitry.

Once address learning agent 330 records that a pattern exists, data sequencer 334 may prefetch data into one ping memory (arranged linearly) while the vector processor is processing data out of a second ping memory (also arranged linearly). In a more specific example, during processing of a first frame of data, data sequencer 334 may generate addresses on memory address bus segment 431 to load data into load ping memory 432a via data bus segment 422. Concurrently, vector processor 306b may read arguments from load ping 434a and write results in store ping memory 434b via data bus segment 424. Later, during a second frame of data, data sequencer 334 may generate addresses on memory address bus segment 431 to store the results from store ping memory 434b in RAM 302 according to addresses in address sequencer memory 332 and load data from RAM 302 according to addresses in address sequencer memory 332 into load ping memory 434a.

Ping memories 432a and 434a may be used to capture linearized data in a prefetch operation from RAM 302 to feed vector ALU 306. Likewise, ping memories 432b and 434b may be used to capture linearized data from vector ALU 306 to be stored in a non-linear fashion in RAM 302. A ping memory may be sized to match or exceed an expected frame size. For example, ping memory 432a may be sized to allow prefetch of input data frame of content while vector ALU 306b is writing output data frame of content to ping memory 432b.

One application of the present disclosure is in a RISCV/RISCV-VP device that comprises of scalar and vector processors. Other applications may be in more traditional vector processing systems and in digital signal processors (DSP) with single instruction multiple data (SIMD) instructions.

In some examples, the data sequencer 334 may be replicated one per ping memory (e.g., 432a, 432b, 434a, 434b) to facilitate transferring data between one ping memory and the RAM 302 while vector processor 306b accesses data of another ping memory.

As illustrated, components of self-learning linearizer 450 including ALA 330, address sequence memory 332, and data sequencer 334, may be added to a RISC-V Vector Processor design. ALA 330 is illustrated as coupled to the memory address bus coupling the processor and the RAM controller 308 to allow observation of addresses of data accesses. Ping memories 432a, 432b, 434a, and 434b may be added to a RISC-V Vector Processor design to couple to address bus 426 and data bus 427 between vector processor 306b and RAM controller 308.

When activated, address generation circuit 334 prefetches data from non-linear address locations to load in a ping memory (e.g., 432a). In some examples, once a frame of data has been loaded into ping memory 432a, in the subsequent frame, vector processor 306b may read the data in ping memory 432a linearly to process that data and may write the processed data to ping memory 432b linearly. Simultaneously utilizing ping memory 432a, address generation circuit 334 may prefetch data from non-linear address locations in RAM 302 to load into ping memory 434a. Address generation circuit 334 may also transfer linearly stored results from ping memory (e.g., 434b) into non-linear address locations in RAM 302. This may work for any strided, irregularly indexed, and/or randomly addressed data used by algorithm kernels. For example, this approach improves performance of FFT de-sampled addressing and/or bit reversed addressing.

Examples of the present disclosure may improve performance of a class of vector processor intensive computations where the address pattern is the same for some predictable data block size. For example, some data access patterns are the same for every frame of data. In another example, a data access pattern may repeat every n^{th} frame. In yet another example, a data access pattern may be predetermined based on some observable event, such as the execution of a particular instruction or access of a particular reference data point. In one example, an address pattern may be recorded in program memory as an addressing “macro” that may be loaded before a block of code is executed. The addressing macro may be used to populate the address sequence memory 332. In some examples, the addressing macro may be stored in firmware or some other library for loading into the address sequence memory 332. In some examples, the address sequence memory 332 may store two or more sequences. For example, the address sequence memory 332 may store an address sequence for loading data from RAM 302 into a ping memory and a postprocessing sequence for storing results from a respective ping memory into RAM 302. In some examples an address sequence macro could include a common pattern such as an n-unit stride pattern. The application code might include an instruction signaling the use of a n-unit stride pattern to initialize the address sequence memory 332 instead of requiring a learning process. In some examples, an application development environment may perform a static or dynamic analysis of code and generate addressing macros and/or address macro invocation instructions.

Vector processor 306b may include a modified instruction set to include instructions or flags to communicate with the data sequencer and the address learning agent. In some examples, vector processor 306 may include an instruction for transferring control of the RAM address bus to the data sequencer. In some examples, vector processor 306 may include an addressing mode for load/store instructions that transfers control of the RAM address bus to the data sequencer.

FIG. 4B is an illustration of vector processing circuit including a data linearizer, according to examples of the present disclosure. Circuit 400 includes RAM 302, RAM controller 308, and processor 306. Circuit 490 also includes a different arrangement of the components of self-learning linearizer 450 that includes address learning agent (ALA) 330, address sequence memory 332, and data sequencer 451. During a learning phase, address learning agent 330 reads memory access addresses from memory address bus 426 and stores those memory access addresses in address sequence memory 332. During this phase, linearizer mode 435 may direct mux 433 to pass addresses from address bus 426 to memory controller 308, which will request data from RAM 302. Memory controller 308 may return the requested data from (or store the results into) the address locations in RAM 302 straight through (as instructed by linearizer mode 435) data sequencer 451 to scalar processor 306a. Once at least two frames of data have been processed, address learning agent 330 may determine that the data is linearizable.

During an execution phase, CPU 306 may set linearizer mode to pass addresses from address sequence memory 332 via alternate address bus 431 to memory controller 308 in a process of prefetching data. Data sequencer 451 may direct memory reads to a load_pong memory of linear memory 460 to preload the next frame of data to process and may direct memory writes from a store_pong memory of linear memory 460 to store the output of vector processor 306b from processing the prior frame of data. Generally concurrent with loading data into the load_pong memory and storing results from the store_pong memory, vector processor 306b may be processing data from a load_ping memory of linear memory 460 and storing results into a store_ping memory of linear memory 460.

One application of the present disclosure is in a RISCV/RISCV-VP device that comprises of scalar and vector processors. Other applications may be in more traditional vector processing systems and in digital signal processors (DSP) with single instruction multiple data (SIMD) instructions. In some examples, CPU 306 may be two separate processors, one scalar and one vector, configured to allow address learning agent 330 to observe address accesses of the scalar processor and configured to allow addresses from address sequence memory 332 to direct memory accesses for the vector processor.

As illustrated, components of self-learning linearizer 450 including ALA 330, address sequence memory 332, and data sequencer 451, may be added to a RISC-V Vector Processor design.

CPU 306 may include a modified instruction set to include instructions or flags to communicate with the data sequencer and the address learning agent. In some examples, vector processor 306b may include an instruction or control code for transferring control of the RAM address bus by setting linearizer mode 435.

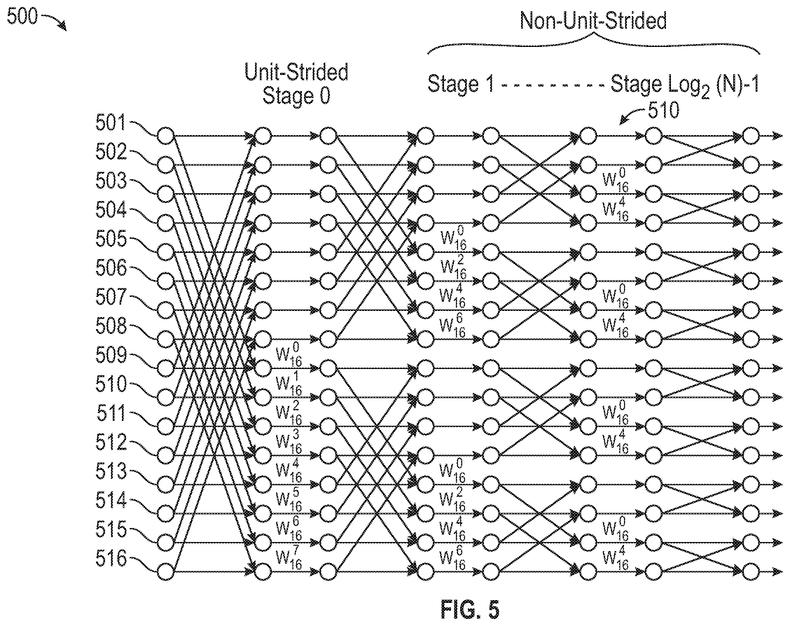

FIG. 5 is an illustration of memory accesses in a multi-state calculation, according to examples of the present disclosure. The addressing of a radix-2 decimation in frequency (DIF) fast Fourier transformation (FFT) is illustrated. Illustrated memory accesses 500 includes a series of computation stages across sixteen data units including stages 520, 521, 522, and 523. At Stage 0, the top computation has as inputs the values 501 and 509. The next computation has as inputs values 502 and 510. These inputs are unit-strided as each adjacent computation accesses adjacent inputs in the same order. Vector processor 306b may execute a vector instruction with the address of 501 and the address of 509 as its inputs and the vector processor 306b can efficiently load both vectors with linear reads and store the output with a linear write. At later stages, the memory accesses are no longer unit-strided. In the clearest example, at Stage 522, the top calculation takes as input values (501, 502, 505, 506, 509, 510, 513, 514) as first operand and (503, 504, 507, 508, 511, 512, 515, 516) as second operand Because of this, vector processor 306b cannot simply load a linear vector from memory for each operand.

Vector processing of non-linearly addressed digital data may be useful in a number of application areas. For example, digital signal processing may be used to extract features of a medical data stream that may indicate medical problems. For example, signals from an electrocardiogram (ECG or EKG) or an electroencephalogram (EEG) may be processed to distinguish diseases or predict medical events. The data may be formatted in a set of time-correlated sample values from the sensor leads. For example, an EKG may provide one to twelve time-correlated sample streams. An EEG may include as many as 256 time-correlated sample streams. In this calculation the first stage of data is linear (i.e., unit-strided addressing). The stages beyond the first stage (Stage0), however, are nonlinear (not unit-strided addressing) as data sets are divided in half and the samples are crossed across each half. Existing vector processors cannot efficiently load and store data for the operations in stages after Stage0.

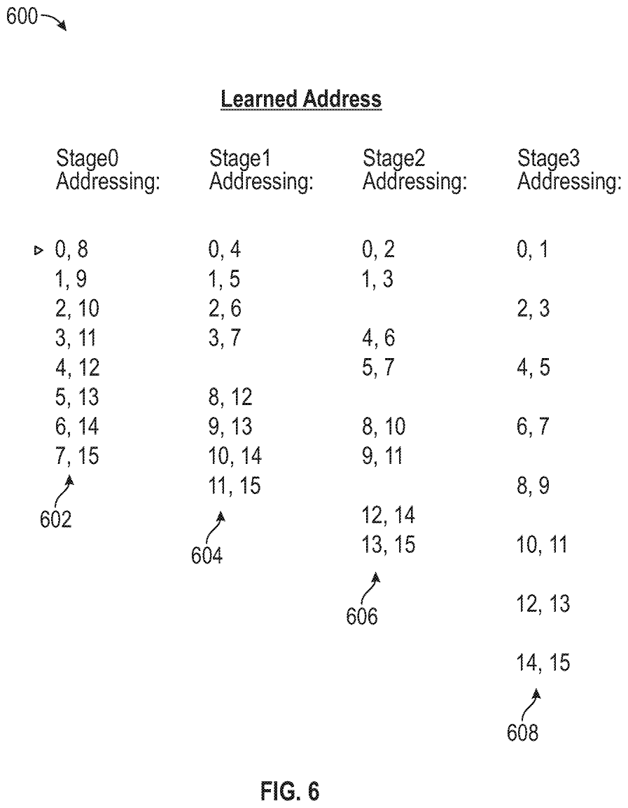

FIG. 6 is an illustration of learned addresses, according to examples of the present disclosure. Table 600 illustrates the memory addresses observed when processing an FFT algorithm, according to certain examples. Memory accesses at Stages 0, 1, 2, and 3 are shown in address lists 602, 604, 606, and 608, respectively. In this figure, Stage 0 addresses 602 list continuous memory addresses 0-7 as one operand and 8-15 as a second operand to a vector instruction. In some examples, each operand can be obtained with a contiguous eight-byte register load. Stage 1 addresses 604 lists addresses (0, 1, 2, 3, 8, 9, 10, and 11) and addresses (4, 5, 6, 7, 12, 13, 14, and 15) as arguments for a vector instruction. In examples where a vector processor accepts an eight-byte operand, these memory addresses are not unit-strided and will require at least two memory operations by the vector processor to load all the values from addresses (0, 1, 2, 3, 8, 9, 10, and 11). At Stage 1, a vector processor would load data from locations 0-3 into half a register and then load 8-11 into the other half and repeat for the other operand, thus doubling the number of load operations for each operand.

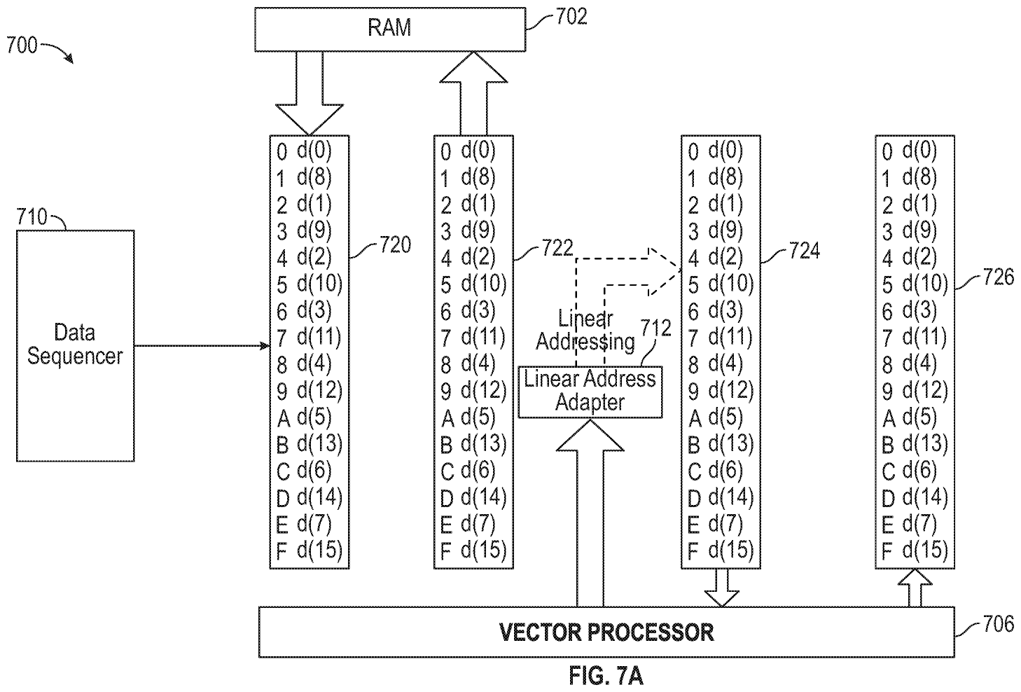

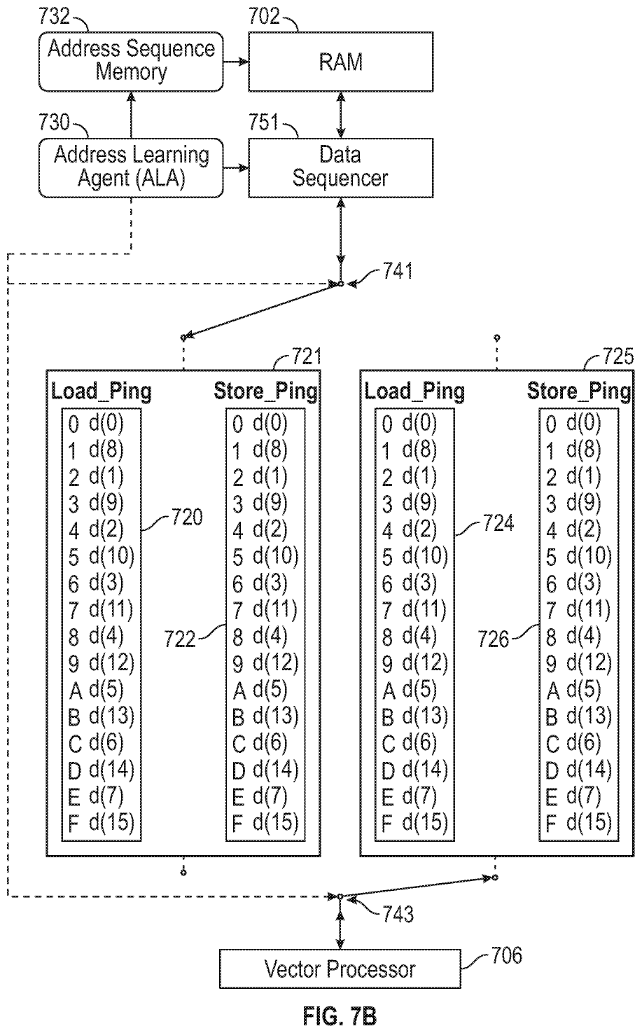

FIG. 7A is an illustration of data addressing, according to examples of the present disclosure. In this example, circuit 700 includes RAM 702, vector processor 706, data sequencer 710, ping memories 720, 722, 724, and 726, and linear address adapter 712. In some examples, linear address adapter 712 may translate RAM addresses to ping memory locations. In this example, linearizer 710 has a record of an address sequence (e.g., 0, 8, 1, 9, . . . ) captured during a learning phase. Linearizer 710 prefetches data for the next frame of data, storing those values in ping memory 720 in linear fashion. Linearizer 710 may also store results output by vector processor 706 in a prior execution cycle to non-linear addresses in RAM 702 (e.g., 0, 8, 1, 9, . . . ) as illustrated in ping memory 724. In some examples, the output addresses may be different than the input addresses. Simultaneous with the loads and stores performed by linearizer 710, vector processor 706 may execute a vector load instruction with unit stride into a specified vector data register starting at a read address pointer. In some examples, linear address adapter 712 redirects a write address of RAM 702 to write to a linearized location in ping memory 724. In some examples, the vector code is modified before processing frames to rewrite the vector instructions to load linearly from the respective ping memory. FIG. 7 also illustrates vector processor 706 writing data arranged in unit-strided order to ping memory 726 and linear address adapter 712 stores the data in addresses in processor memory 702 according to the address sequence (e.g., 0, 8, 1, 9, . . . ).

Where the present disclosure mentions vector instructions for interacting with linearizer 710 or linear address adapter 712, or other structures disclosed herein vector processor may involve modification of the processor and its supported instruction set to support these instructions. For example, one or more additional addressing modes may be implemented to support selection of a load ping memory and a store ping memory.

FIG. 7B is an illustration of data addressing, according to examples of the present disclosure. In this illustration, ALA 730 captures a sequence of non-linear memory addresses as they are accessed by a scalar processor during a learning process and stores the memory access sequences in address sequence memory 732. Address sequence memory 732 generates addresses for prefetching data from RAM 702. ALA 730 also provides sequence information to data sequencer 751 and memory selectors 741 and 743. Data sequencer 751 routes the prefetched data with input from ALA 730 into the load_ping portion of ping memory 721 and arranges the data linearly in that load_ping portion. Data sequencer 751 may also store calculation results from the store_ping portion of ping memory 721 into non-linear locations in RAM 702.

Concurrent with this prefetch/postprocess store activity, vector processor 706 may be reading input data from load_pong portion of ping memory 725 and writing results to the store_pong portion of ping memory 725.

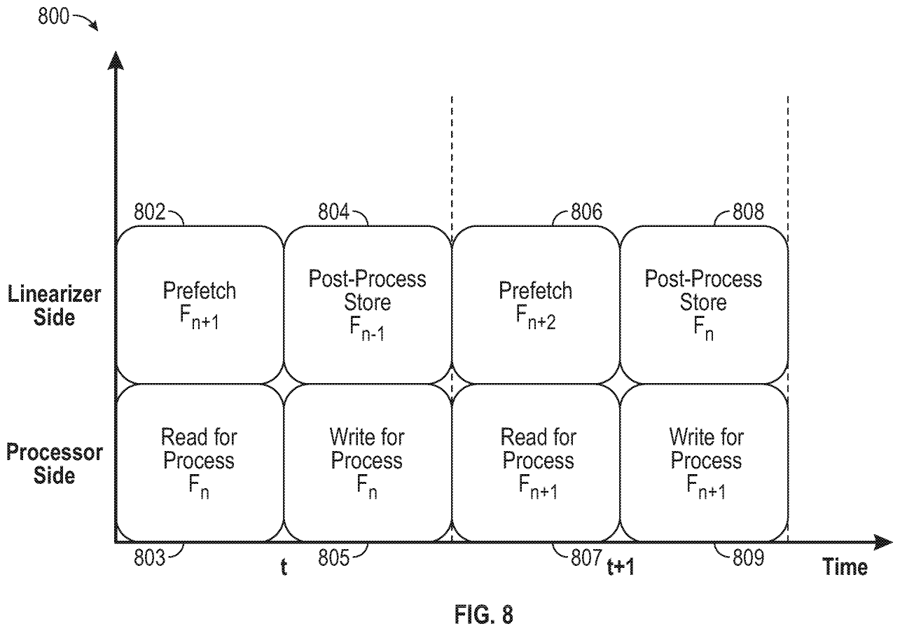

FIG. 8 is an illustration of data access timing, according to examples of the present disclosure. As time progresses along the x-axis of graph 800, this figure illustrates what effort is underway for the self-learning linearizer (tasks 802, 804, 806, and 808) and for the vector processor (803, 805, 807, and 809). For the first time window, the linearizer prefetches data for frame Fₙ₊₁ at 802 and stores the prefetched data into a load portion of a first ping memory and stores results from the vector processor for Fₙ₋₁ at 804 into a store portion of the first ping. In the same time window, the vector processor reads operands from a load portion of a second ping memory for frame Fₙ at 803 and writes results for frame Fₙ at 805 to a store portion of the second ping memory. In the next time window, the self-learning linearizer prefetches input data for frame Fₙ₊₂ into the load portion of the second ping memory at 806 and stores results for Fₙ from the store portion of the second ping memory into RAM at 808 and the vector processor reads operands from the load portion of the first ping memory for frame Fₙ₊₁ at 807 and writes results for frame Fₙ₊₁ to the store portion of the second ping memory at 809.

FIG. 9 is an illustration of a method for performing a self-learning data linearization process, according to examples of the present disclosure. Method 900 begins learning (during a learning phase) at block 902. At block 904, the scalar processor executes a program to perform computations while the self-learning linearizer captures a sequential record of each memory access made by the scalar process for two frames of processing. At block 906, if the memory access sequence for the first frame does not match the memory access sequence for the second frame, the self-learning linearizer determines the data is not linearizable and the method terminates at block 910. If the two memory access sequences match, the method continues to block 908. At block 908, the self-learning linearizer updates a lookup table in the address sequence memory wherein the lookup table includes the memory addresses read as prefetch addresses and the memory addresses written as post processing store addresses. Also at block 908, in some embodiments, the self-learning linearizer sets linearizable flags in the executable code to signal the vector processor (during an execution phase) to use the linearization hardware during execution. Also at block 908, in some embodiments, the self-learning linearizer sets linearizable flags in the lookup table such that when the vector processor begins accessing the same sequence of memory addresses the data sequencer can override and prefetch/postload data in a more efficient manner. The method stops at block 910.

In an execution phase, the method begins executing the program on the vector processor to perform computations. At block 954, the vector processor looks to see if linearizable flags are set. If not, the method continues at block 958. If the linearizable flags are set, at block 956 the vector processor configures the linearization hardware to access unit strided data stored in a ping memory. At block 958, the vector processor executes the program. The method stops execution at block 960 once the program has completed.

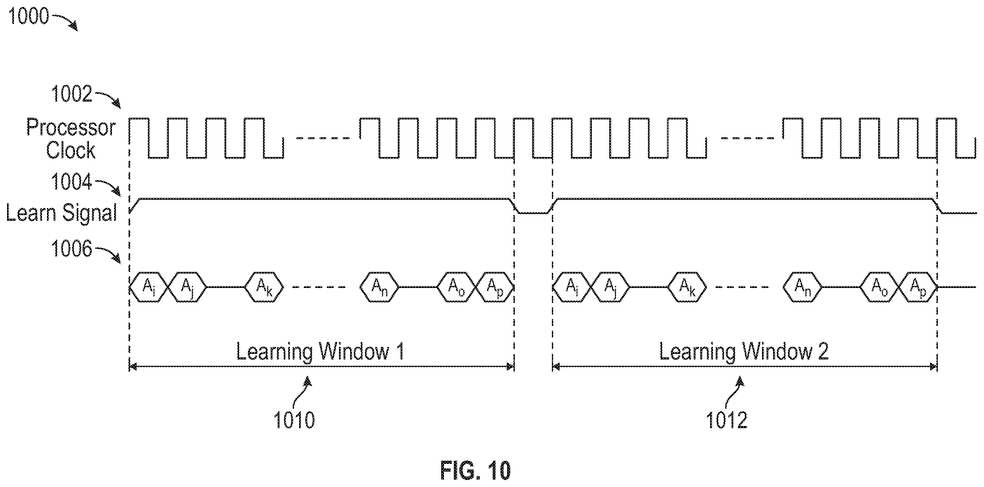

FIG. 10 is an illustration of data access timing, according to examples of the present disclosure. Time progresses along the x-axis in FIG. 1000. Processor clock 1002 proceeds regularly. Assertion of learn signal 1004 by processor 306 while processing a frame indicates the start and end of memory accesses for a frame of data to be processed under observation by ALA 330. As the processor 306 accesses RAM 302 the addresses are indicated in address bus 1006 and read by ALA 330. Each address is synchronized with processor clock 1002. The sequence of addresses in address sequence 1010, e.g., {Aᵢ, Aⱼ, Aₖ, . . . Aₙ, Aₒ, and Aₚ}, is non-linear and not unit strided. After address sequence 1010 has been captured by ALA 330, learn signal 1004 is toggled off by processor 306 and is later reasserted to signal a new frame of data accesses to be observed by ALA. In this example, the sequence of addresses in address sequence 1012, e.g., {Aᵢ, Aⱼ, Aₖ, . . . Aₙ, Aₒ, and Aₚ} matches address sequence 1010. At the end of address sequence 1012, ALA 330 confirms the match and stores address sequence 1010 in a lookup table in address sequence memory 332. In some examples where address sequence 1010 does not match address sequence 1012, address learning adapter may identify no match and neither address sequence 1010 nor address sequence 1012 is stored in the lookup table.

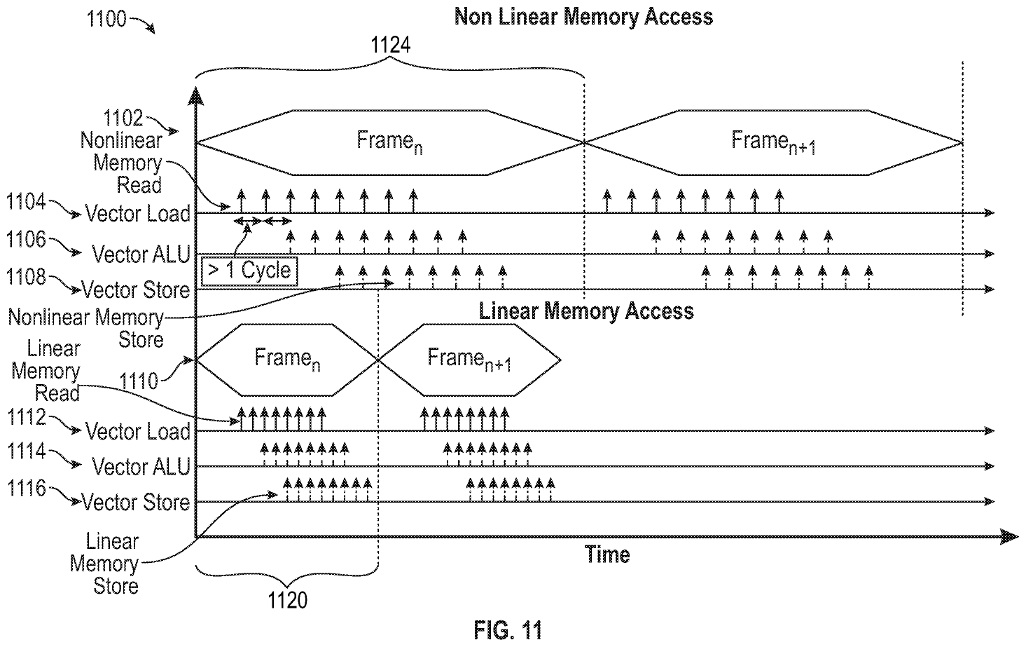

FIG. 11 is an illustration of data access timing, according to examples of the present disclosure. Timing diagram 1100 illustrates time progressing along the x-axis. The top portion of the diagram illustrates the relative inefficiency of non-linear memory access by a vector processor. In timing line 1102, two frames of data, frame, and frameₙ₊₁ are illustrated. Each frame of data may represent a portion of a video stream, audio stream, capture of sensor data, or some other block of streaming data to be processed. Timing line 1104 illustrates the load accesses for register(s) of data for processing by the vector ALU. Because the data is non-linearly addressed, vector loads along timing line 1104 are spaced more than one processor cycle apart. Timing line 1106 illustrates the timing of vector ALU processing operations. A vector ALU processing operation with one register operand may begin after that source register has been loaded. In one example, the first vector operation on timing line 1106 occurs after two vector load operations on timing line 1104. Timing line 1108 illustrates the timing of vector store operations, which cannot begin until after vector ALU processing operation begin on a particular frame of data, e.g., frameₙ. Because the input data is not linear, each vector load requires at least two memory operations, which ties up the available memory bandwidth. Thus, vector store operations cannot begin until at least part of the last vector load operation for frameₙ has completed (which frees up some memory bandwidth). Further, the processing of frameₙ₊₁ cannot begin until after completion of the last vector store operation for frameₙ. This process repeats for frameₙ₊₁ and subsequent frames.

The bottom portion of the diagram illustrates the relative efficiency of linear memory access by a vector processor, such as when a self-learning linearizer is used. In timing line 1110, two frames of data, frame, and frameₙ₊₁ are illustrated. Each frame of data may represent a portion of a video stream, audio stream, capture of sensor data, or some other block of streaming data to be processed. Timing line 1112 illustrates the load accesses for a register of data for processing by the vector ALU. Because the data in is linearly addressed, vector loads along timing line 1112 are spaced one processor cycle apart. Timing line 1114 illustrates the timing of vector ALU processing operations. A vector ALU processing operation cannot begin until any operand(s) have been loaded. In some examples, the first vector operation on timing line 1114 occurs after two vector load operations on timing line 1112. Timing line 1116 illustrates the timing of vector store operations, which cannot begin until after vector ALU processing operation begins on a particular frame of data, e.g., frameₙ. Because the data may be stored in linear fashion to a ping memory, the first vector store can occur one clock cycle after completion of the first vector ALU operation on timing line 1114. Further, the processing of frameₙ₊₁ cannot begin until after completion of the last vector store operation for frameₙ. This process repeats for frameₙ₊₁ and subsequent frames.

In this example, frame processing time 1120 for frameₙ of linearized data may be approximately less than half of frame processing time 1124 of non-linearized data without the self-learning linearizer.

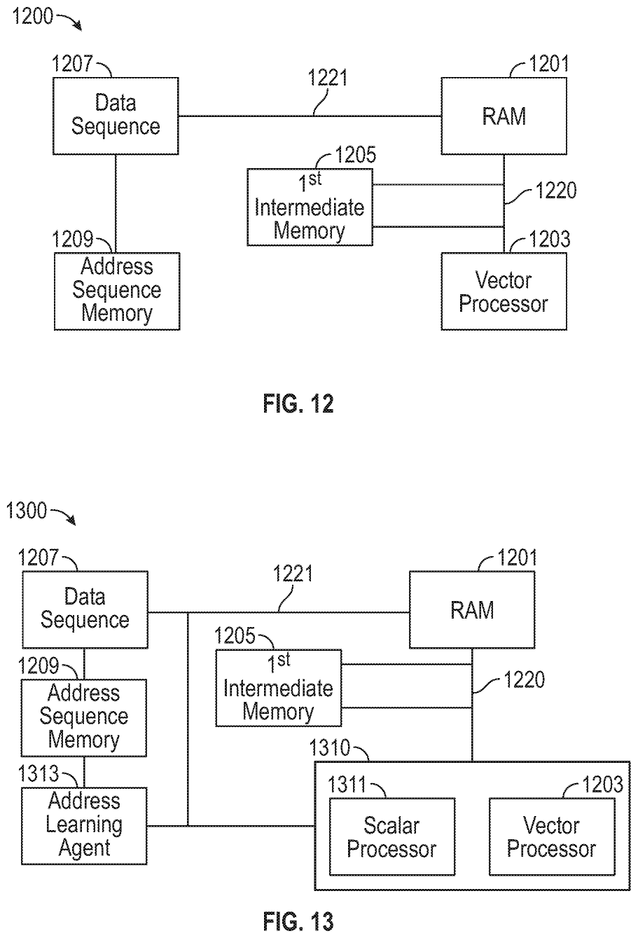

FIG. 12 is an illustration of an example system for improving performance of a computer with a vector processor, according to examples of the present disclosure. System 1200 includes RAM 1201 coupled to vector processor 1203. First intermediate memory 1205 is coupled to RAM 1201 and vector processor 1203. Data sequencer 1207 is coupled to address lines 1221 of RAM 1201 and address sequence memory 1209. Address sequence memory 1209 contains a set of non-linear RAM addresses corresponding to linear locations in first intermediate memory 1205. RAM 1201 stores data to be accessed by vector processor 1203 in nonlinear fashion and may also store data to be accessed by vector processor 1203 in linear fashion. Data sequencer 1207 may perform a prefetch operation based on RAM addresses stored in address sequence memory 1209 to preload non-linear data from RAM 1201 via data lines 1220 into first intermediate memory 1205. Vector processor 1203 may load a linearized vector of data from first intermediate memory 1205 as a vector operand before executing a vector operation on that operand. In some examples, a second intermediate memory is provided to allow prefetching data from RAM into the second intermediate memory while the vector processor reads operands from the first intermediate memory.

FIG. 13 is an illustration of an example system for improving performance of a computer with a vector processor, according to examples of the present disclosure. System 1300 includes RAM 1201 coupled to CPU 1301, which includes vector processor 1203 and scalar processor 1311. First intermediate memory 1205 is external to, and communicatively coupled to, RAM 1201 and processor 1310. Data sequencer 1207 is coupled to address lines 1221 of RAM 1201 and to address sequence memory 1209. RAM 1201 stores data to be accessed by vector processor 1203 in nonlinear fashion and may also store data to be accessed by vector processor 1203 in linear fashion. Data sequencer 1207 may perform a prefetch operation using addresses stored in a prefetch address lookup table within address sequence memory 1209 to preload non-linear data from RAM 1201 into first intermediate memory 1205. Vector processor 1203 may load a linearized vector of data from first intermediate memory 1205 as a vector operand before executing a vector operation on that operand.

System 1300 also includes address learning agent 1313, which is coupled to address lines 1221 of RAM 1201. In a learning mode, scalar processor 1311 the calculations of a vector program may be executed on scalar processor 1311 with control code to signal the start and end of a frame processing cycle to address learning agent 1313. As scalar processor 1311 loads operands from and stores results to main memory 1201, address learning agent 1313 captures a first set of memory access addresses by scalar processor 1311 for a first frame of data and a second set of memory access addresses by scalar processor 1311 for a second frame of data. After the second frame of data is analyzed, the address learning circuit compares the first set of memory access addresses and the second set of memory access addresses and determines whether the sets are identical. If the two sets are identical, address learning agent 1313 stores one of the sets of memory access addresses to address sequence memory 1209 for later access by data sequencer 1207. In some examples, address learning agent 1313 may differentiate between memory load access addresses and memory store access addresses. Address learning circuit 1313 maps non-linear load access RAM addresses to corresponding linear intermediate memory addresses of first intermediate memory 1205 and records the corresponding addresses in a prefetch address lookup table within address sequence memory 1209. Address learning agent 1313 maps non-linear store access RAM addresses to corresponding linear intermediate memory addresses and records the corresponding addresses in a post processor address lookup table within address sequence memory 1209.

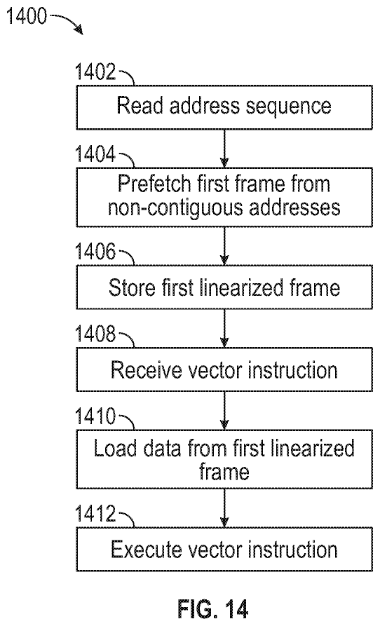

FIG. 14 is an illustration of an example method for improving performance of a computer with a vector processor, according to examples of the present disclosure. Method 1400 includes block 1402, wherein data sequencer 334 reads a sequence of non-contiguous addresses pertaining to the first frame of data from a prefetch address lookup table in address sequence memory 332. At block 1404, the data sequencer 334 loads a first frame of data from RAM 302 using that sequence of non-contiguous addresses. At block 1406, the prefetch linearizer stores that first frame of data in a first intermediate memory as a first linearized frame of data. Blocks 1402, 1404, and 1406 may occur as a recurring process of reading an address, loading data from that address, storing data from that address in the first intermediate memory and may repeat until data from the entire sequence of non-contiguous addresses has been loaded into the first intermediate memory. At block 1408, the vector processor may receive a vector instruction having at least one vector operand. At block 1410, a first linearized frame of data from the first intermediate memory may be fetched into a vector register of the vector processor. At block 1412, the vector processor executes the vector instruction with the vector register as the at least one vector operand.

The system may be implemented in any suitable manner, such as by a device, die, chip, analog circuitry, digital circuitry, instructions for execution by a processor, or any combination thereof. The system may be implemented by, for example, a microcontroller and a sensor. Although some portions of the system are described herein as implemented by the microcontroller, such portions may be implemented instead by the sensor or by instrumentation coupling the microcontroller and the sensor. Similarly, although some portions of the system are described herein as implemented by the sensor, such portions may be implemented instead by the microcontroller or by instrumentation coupling the microcontroller and the sensor. Moreover, instead of a microcontroller, the system may be implemented by a server, computer, laptop, or any other suitable electronic device or system.

Although example embodiments have been described above, other variations and embodiments may be made from this disclosure without departing from the spirit and scope of these embodiments.

What is claimed is:

1. A circuit, comprising:
a first intermediate memory communicatively coupled with a vector processor and a RAM, wherein the vector processor is communicatively coupled with the RAM;
an address sequence memory to store non-linear RAM addresses corresponding to linear locations in the first intermediate memory;
a data sequencer to read a first frame of data from the RAM to the first intermediate memory based on addresses stored in the address sequence memory; and
the first intermediate memory to provide a linearized frame of data to the vector processor to execute a vector instruction.

2. The circuit of claim 1, comprising:
a second intermediate memory communicatively coupled to the vector processor and the RAM;
wherein the data sequencer is to read a second frame of data from the RAM to the second intermediate memory based on addresses stored in the address sequence memory.

3. The circuit of claim 1, comprising:
a scalar processor communicatively coupled to the RAM; and
an address learning agent to:
record a first set of memory access addresses by the scalar processor for the first frame of data; and
store the first set of memory access addresses in the address sequence memory.

4. The circuit of claim 3, wherein the address learning agent is to:
record a second set of memory access addresses by the scalar processor for a second frame of data;
determine the first set of memory access addresses matches the second set of memory access addresses; and
indicate the match to the scalar processor.

5. The circuit of claim 1, comprising the data sequencer to write data from the first intermediate memory to the RAM based on addresses stored in the address sequence memory.

6. The circuit of claim 1, wherein the address sequence memory and the first intermediate memory are external to the RAM.

7. The circuit of claim 1, wherein the vector processor instruction set includes an indicator to fetch data from the first intermediate memory instead of the RAM.

8. A circuit, comprising:
a first intermediate memory communicatively coupled to a vector processor, a scalar processor, and a RAM, the RAM to store a vector program for performing calculations;
an address sequence memory to store non-linear RAM addresses corresponding to linear locations in the first intermediate memory;
an address learning agent to, while the scalar processor performs the calculations of the program:
capture a first set of memory access addresses issued by the scalar processor to the RAM during processing of a first frame of data;
map the set of memory access addresses to linear locations in the first intermediate memory; and
store in the address sequence memory the mapping of the set of memory access addresses to the linear locations in the first intermediate memory; and
a data sequencer to read a first frame of data from the RAM and store the first frame of data to the first intermediate memory based on addresses stored in the prefetch address lookup table,
the first intermediate memory to thereby provide linearized data to the vector processor to execute a vector instruction.

9. The circuit of claim 8, comprising:
a selector to select one of the first intermediate memory and a second intermediate memory from which to fetch linearized data.

10. The circuit of claim 8, wherein the address learning agent to:
record a second set of memory access addresses by the scalar processor for the second frame of data; and
determine the first set of memory access addresses matches the second set of memory access addresses.

11. The circuit of claim 10, wherein the scalar processor to, based on the match determination, modify the program to access the first intermediate memory.

12. The circuit of claim 8, comprising:
a second intermediate memory to store results generated by the vector processor; and
the data sequencer to write the results of the vector processor from the second intermediate memory to the RAM based on RAM addresses stored in the address sequence memory.

13. The circuit of claim 8, wherein the address sequence memory and the first intermediate memory are external to the RAM.

14. The circuit of claim 8, wherein the vector processor supports an instruction to access data from the first intermediate memory.

15. A method comprising:
reading a sequence of non-contiguous addresses from an address sequence memory;
prefetching a first frame of data from a RAM using the sequence of non-contiguous addresses;
storing that first frame of data in a first intermediate memory as a first linearized frame of data;
receiving a vector load instruction to load a portion of the first frame of data;
loading the portion of the first frame of data into the vector processor from the first intermediate memory; and
executing the vector instruction with the received portion of the first frame of data as an operand.

16. The method of claim 15, comprising:
selecting a second intermediate memory from which to load linearized data into the vector processor.

17. The method of claim 15, comprising:
receiving scalar instructions equivalent in result to the vector instruction at a scalar processor;
recording a first set of memory access addresses consisting of each memory access address loaded from RAM while executing the scalar instructions to process the first frame of data;
linearizing the first set of memory access addresses; and
storing the linearized memory access addresses in the address sequence memory.

18. The method of claim 17, comprising:
recording a second set of memory access addresses in executing the scalar instructions to process a second frame of data; and
comparing the first set of memory access addresses and second set of memory access addresses to determine a match.

19. The method of claim 15, comprising:
storing in the address sequence memory RAM addresses corresponding to locations in a second intermediate memory;
during execution of the vector instruction, storing a result in the second intermediate memory; and
writing the result from the second intermediate memory to the RAM based on one of the addresses corresponding to locations in the second intermediate memory.

20. The method of claim 19, comprising:
determining from the vector instruction that execution results will be stored in the second intermediate memory.
